(19) United States
(12) Patent Application Publication
(10) Pub. No.: US 2015/0189072 A1
(43) Pub. Date: Jul. 2, 2015

(54) INTELLIGENT ANCILLARY ELECTRONIC DEVICE

(71) Applicants: SAURIN SHAH, Portland, OR (US); WENDY MARCH, Portland, OR (US); RICHARD HANNAH, Hillsboro, OR (US)

(72) Inventors: SAURIN SHAH, Portland, OR (US); WENDY MARCH, Portland, OR (US); RICHARD HANNAH, Hillsboro, OR (US)

(21) Appl. No.: 14/142,731

(22) Filed: Dec. 27, 2013

(51) Int. Cl. H04M 3/02; H04W 76/02

(52) U.S. Cl. CPC H04M 3/02; H04W 76/02

(57) ABSTRACT

In one example a controller comprises logic, at least partially including hardware logic, configured to receive a signal from a remote electronic device, and in response to the signal, to present an announcement of an incoming call on the remote device, receive an instruction for the incoming call, and in response to a determination that the instruction is a greeting, to buffer the greeting, instruct the remote electronic device to connect the call, and present the greeting on the call. Other examples may be described.

### RELATED APPLICATIONS

None.

### BACKGROUND

The subject matter described herein relates generally to the field of electronic devices and more particularly to intelligent ancillary electronic devices.

Many electronic devices such as laptop computers, netbook style computers, tablet computers, mobile phones, electronic readers, and the like have communication capabilities, e.g., voice and text messaging, built into the devices. In some circumstances it may be useful to communicate with such electronic devices using an interface on ancillary electronic devices such as headsets, computer-equipped glasses, or the like. Accordingly systems and techniques to provide for intelligent ancillary electronic devices may find utility.

### BRIEF DESCRIPTION OF THE DRAWINGS

The detailed description is described with reference to the accompanying figures.

FIG. 1 is a illustrations of exemplary electronic devices which may be adapted to work with intelligent recording in accordance with some examples.

FIG. 2 is a schematic illustration of components of an intelligent ancillary electronic device in accordance with some examples.

FIG. 3 is a high-level schematic illustration of an exemplary architecture to implement an intelligent ancillary device in accordance with some examples.

FIGS. 4 and 5 are flowcharts illustrating operations in a method to implement intelligent ancillary devices in accordance with some examples.

FIGS. 6-10 are schematic illustrations of electronic devices which may be adapted to implement intelligent recording in accordance with some examples.

### DETAILED DESCRIPTION

Described herein are exemplary systems and methods to implement intelligent ancillary electronic devices. In the following description, numerous specific details are set forth to provide a thorough understanding of various examples. However, it will be understood by those skilled in the art that the various examples may be practiced without the specific details. In other instances, well-known methods, procedures, components, and circuits have not been illustrated or described in detail so as not to obscure the particular examples.

Briefly, the subject matter described here addresses concerns set forth above at least in part by providing an intelligent ancillary electronic device which includes a controller with logic to manage communication with a remote electronic device. For example, the remote electronic device may be embodied as a mobile communication or computing device, a mobile phone or the like, and the ancillary electronic device may be embodied as a wearable device, a headset or the like.

The controller in the ancillary electronic device may implement operations which enable the ancillary electronic device to answer incoming calls with a single phrase greeting. For example, logic, either on the remote electronic device or on the ancillary electronic device, may recognize an incoming call and may generate a signal which triggers the ancillary electronic device to present an announcement of the incoming call. The logic may further include one or more predetermined greetings which may be tailored for specific callers.

When the ancillary electronic device receives an instruction for the call logic on the ancillary electronic device may determine whether the received instruction represents a greeting for the call. In the event that the instruction represents a greeting the greeting may be buffered in memory on either the ancillary electronic device or on the remote electronic device. The ancillary electronic device then instructs the remote electronic device to connect the call and present the greeting on the call. Thus, the ancillary electronic device is able to answer an incoming call with a single-phrase greeting.

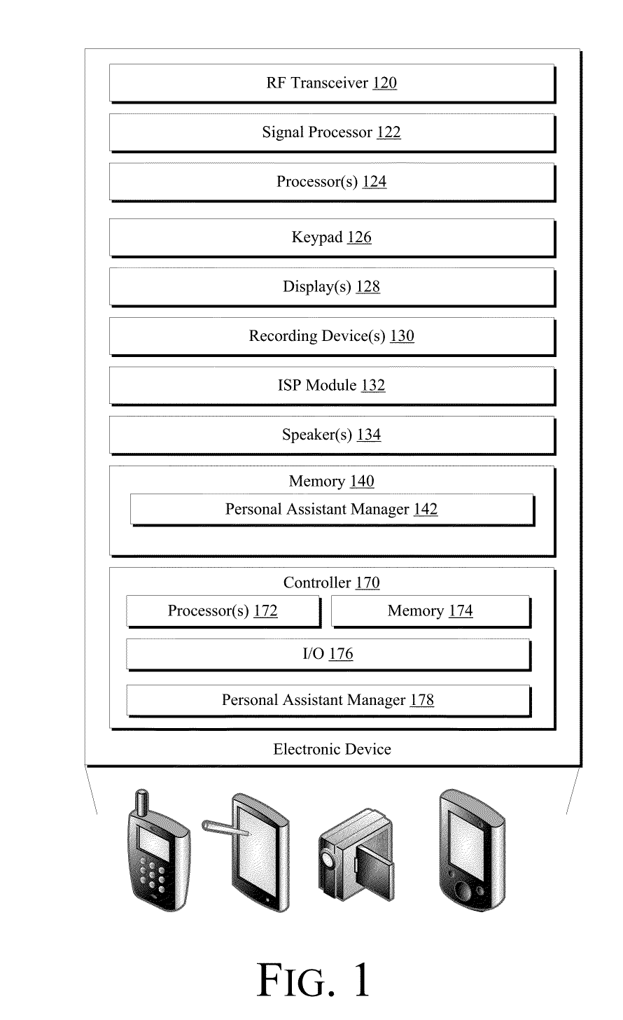

Specific features and details will be described with reference to FIGS. 1-10, below.

FIG. 1 is a schematic illustration of an example of a remote electronic device 100. In some aspects remote electronic device 100 may be embodied as a mobile telephone, a tablet computing device, a personal digital assistant (PDA), a notepad computer, a video camera, a wearable device like a smart watch, smart wrist band, smart headphone, or the like. The specific embodiment of remote electronic device 100 is not critical.

In some examples remote electronic device 100 may include an RF transceiver 120 to transceive RF signals and a signal processing module 122 to process signals received by RF transceiver 120. RF transceiver 120 may implement a local wireless connection via a protocol such as, e.g., Bluetooth or 802.11X. IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Remote electronic device 100 may further include one or more processors 124 and a memory module 140. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit. In some examples, processor 124 may be one or more processors available from Intel® Corporation of Santa Clara, Calif. Alternatively, other processors may be used, such as Intel's Itanium®, XEON™, ATOM™, and Celeron® processors. Also, one or more processors from other manufactures may be utilized. Moreover, the processors may have a single or multi core design.

In some examples, memory module 140 includes random access memory (RAM); however, memory module 140 may be implemented using other memory types such as dynamic RAM (DRAM), synchronous DRAM (SDRAM), and the like. Memory 140 may comprise one or more applications including a personal assistant manager 142 which execute on the processor(s) 124.

Remote electronic device 100 may further include one or more input/output interfaces such as, e.g., a keypad 126 and one or more displays 128, speakers 134, and one or more recording devices 130. By way of example, recording device(s) 130 may comprise one or more cameras and/or microphones An image signal processor 132 may be provided to process images collected by recording device(s) 130.

In some examples remote electronic device 100 may include a low-power controller 170 which may be separate from processor(s) 124, described above. In the example depicted in FIG. 1 the controller 170 comprises one or more processor(s) 172, a memory module 174, an I/O module 176, and a personal assistant 178. In some examples the memory module 174 may comprise a persistent flash memory module and the personal assistant 178 may be implemented as logic instructions encoded in the persistent memory module, e.g., firmware or software. The I/O module 176 may comprise a serial I/O module or a parallel I/O module. Again, because the controller 170 is physically separate from the main processor(s) 124, the controller 170 can operate independently while the processor(s) 124 remains in a low-power consumption state, e.g., a sleep state. Further, the low-power controller 170 may be secure in the sense that the low-power controller 170 is inaccessible to hacking through the operating system.

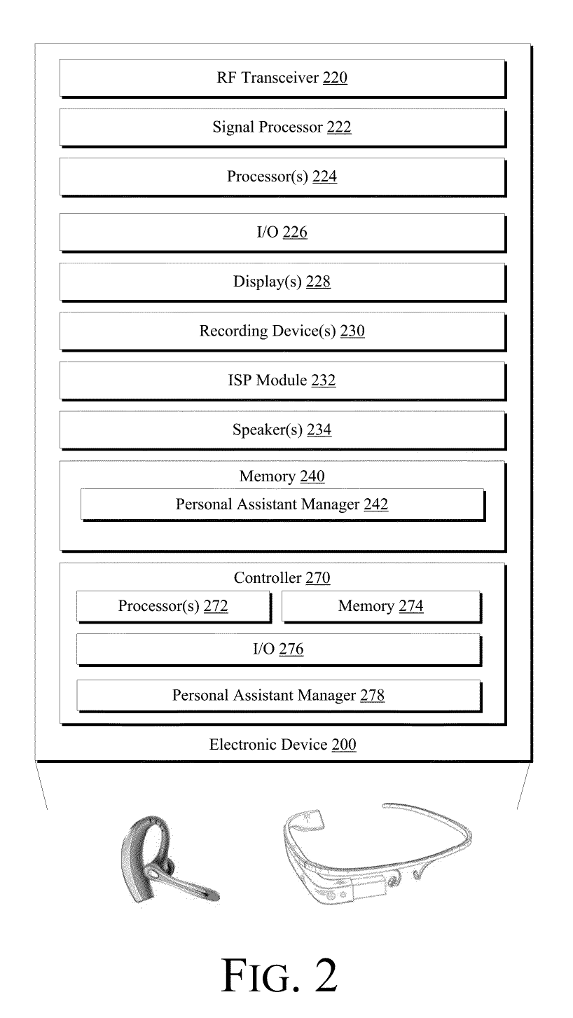

FIG. 2 is a schematic illustration of components of an intelligent ancillary electronic device 200 in accordance with some examples. Many of the components of ancillary electronic device 200 may be the same as the corresponding components for the remote electronic device 100 depicted in FIG. 1. In the interest of brevity and clarity, the description of these components will not be repeated. As illustrated in FIG. 2, in some examples the ancillary electronic device 200 may be implemented as a wearable electronic device such as an earpiece or a headset.

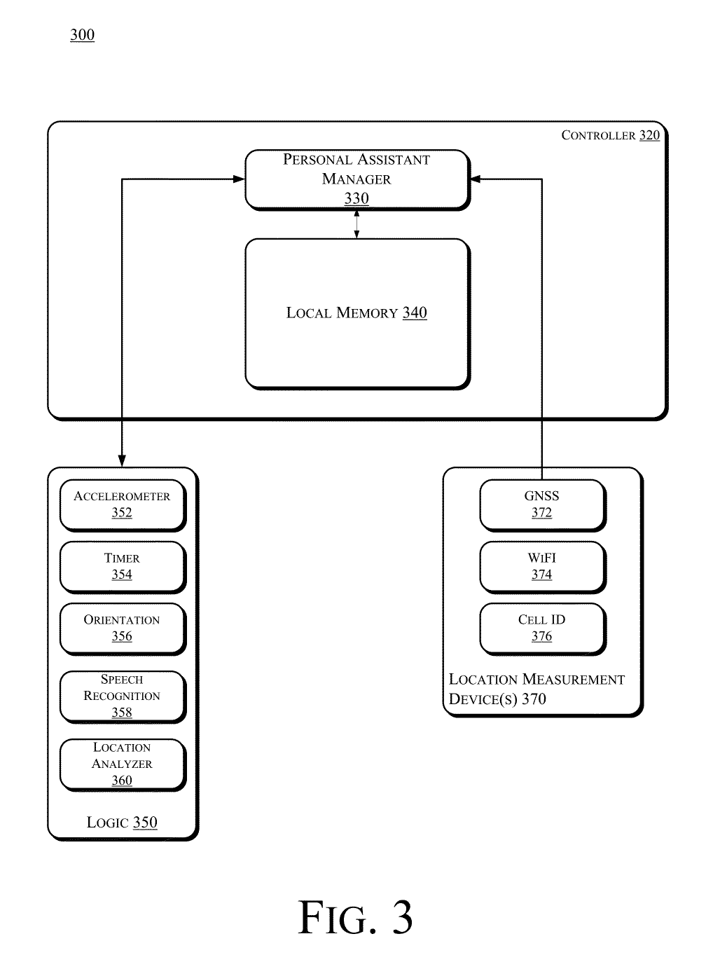

FIG. 3 is a high-level schematic illustration of an exemplary architecture to implement an intelligent ancillary device in accordance with some examples. Referring to FIG. 3, a controller 320 may be embodied as general purpose processor such as processors 124 or as a low-power controller such as controllers 270. Controller 320 may implement a personal assistant manager 330 to manage interactions with a personal manager be embedded in a remote electronic device. By way of example, personal assistant manger 330 may manage interactions with one or more personal assistants 142/178 in an electronic device 100.

Controller 320 may be communicatively coupled to one or more logic components 350 which provide information that may be used to manage interactions with a personal assistant. For example, logic components 350 may include accelerometer logic 352, timer logic 354, orientation logic 356, a speech identifier 358, and a location analyzer 360.

Controller 320 may also be communicatively coupled to one or more location measurement devices 370, which may include a GNSS device 372, a WiFi device 374 and a cellular network device 376. GNSS device 372 may generate location measurements using a satellite network such as the Global Positioning System (GPS) or the like. WiFi device 374 may generate location measurements based on a location of a WiFi network access point. Similarly, Cell ID device 376 may generate location measurements base on a location of a cellular network access point.

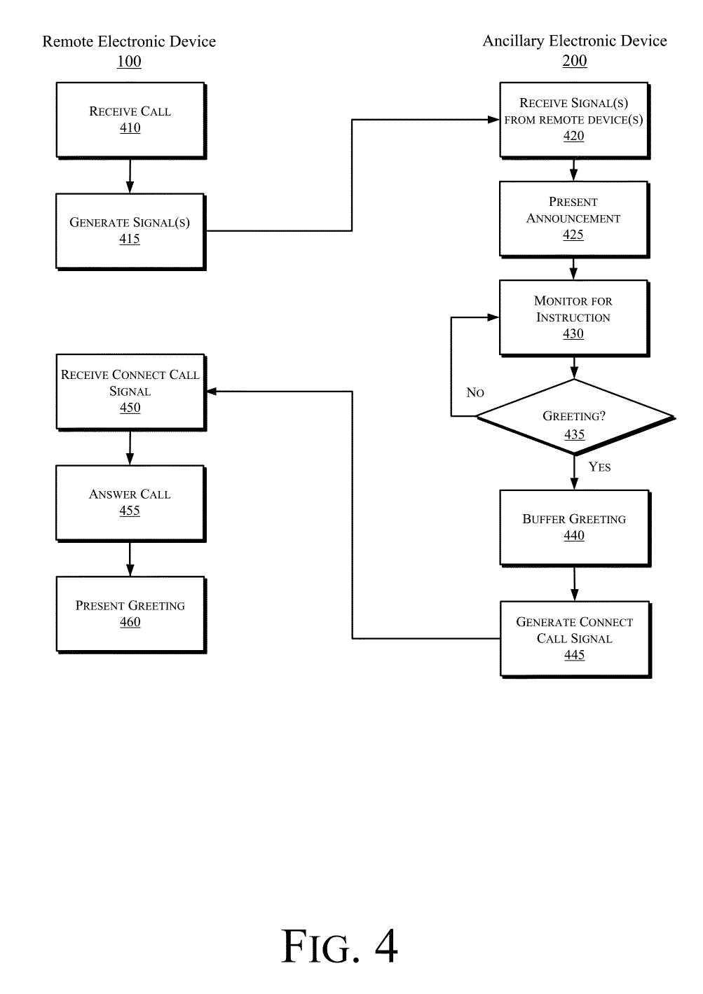

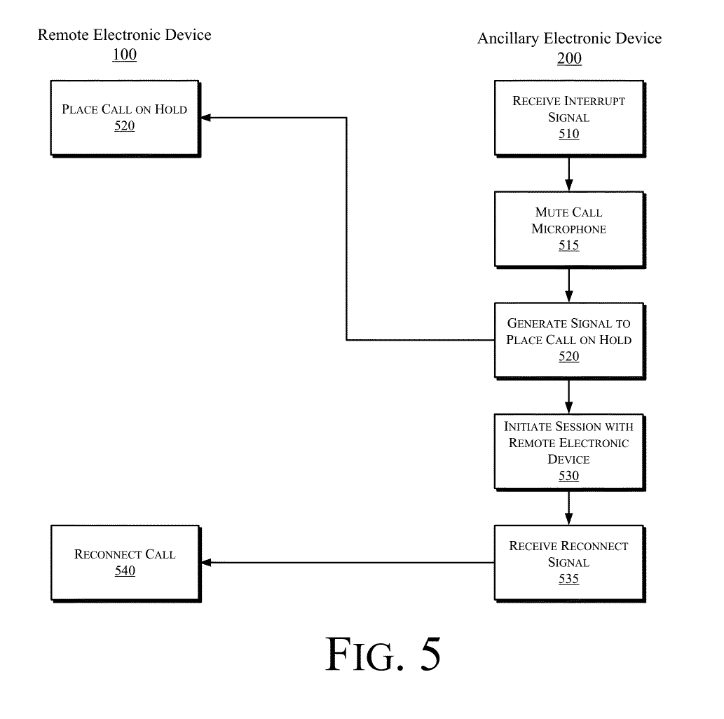

Having described various structures to implement intelligent recording in electronic devices, operating aspects will be explained with reference to FIGS. 4-5, which are flow charts illustrating operations in a method to implement intelligent ancillary electronic devices. Some operations depicted in the flowchart of FIGS. 4-5 may be implemented by the personal assistant 142/178 of the remote electronic device 100 or the personal assistant mangers 242/278 of the respective electronic devices 100, 200.

Referring first to FIG. 4, at operation 410 the remote electronic device 100 receives a call. For example, referring briefly to FIG. 3, in some examples the remote electronic device 100 may receive a call from another remote electronic device 100 via network 340.

At operation 415 the remote electronic device 100 generates one or more signals in response to the call. In some examples the personal assistant 142 in electronic device 100 may compare the origin of the incoming call with contact information in electronic device to determine the identity of the incoming caller. If the incoming call originated from a source identified in the contacts then the identity of the source may be included in the signal(s). By contrast if the incoming call originated from an unknown source then an identifier associated with the origin of the incoming call (e.g., the phone number) may be included in the signal(s). The signal(s) may be forwarded to ancillary electronic device 200.

At operation 420 the ancillary electronic device 200 receives the signal(s) from remote electronic device 100 and at operation 425 the ancillary electronic device 200 presents an announcement of the incoming call on an input/output (I/O) device. By way of example, ancillary electronic device 200 may announce the origin of the incoming call in an audible alert such as “incoming call from Sarah.” Alternatively, or in addition, the electronic device 200 may present a visual alert such on one or more display(s) 228 or may present a tactile alert, e.g. a vibration or the like.

At operation 430 the personal assistant manager 242 in ancillary electronic device 200 monitors the various input/output devices in ancillary electronic device 200 for instructions regarding how to process the incoming call. In some examples the ancillary electronic device 200 may receive a voice command via a voice input device such as a microphone while in other examples the ancillary electronic device 200 may receive a tactile command via an input device such as a button or keypad. In some examples a voice command may be processed by speech recognition logic 358 to ensure that the voice command is from an authorized user of the ancillary electronic device.

In further examples the ancillary electronic device may receive a command via one or more of the logic modules 350. For example, a user of a wearable device incorporating ancillary electronic device 200 may respond to a question from personal assistant 142/178 by a predetermined movement such as nodding or shaking the head or moving the ancillary electronic device in a predetermined pattern. The accelerometer logic 352 and/or orientation logic 356 may generate outputs in response to the acceleration and/or orientation of the ancillary electronic device. If the outputs from accelerometer logic 352 and/or orientation logic 356 correspond with a predetermined motion such as nodding or shaking the head then the motion may be processed as an input. Further, in some examples the motion must exceed a time threshold, which may be measured by timer logic 354.

In further examples the ancillary electronic device 200 may receive a command that is based at least in part on a location of the ancillary electronic device. By way of example, personal assistant manager 330 may receive location information from one or more location measurement devices 370. For example, if the location measurement devices 370 indicate that the ancillary electronic device 200 is in a particular location (e.g., home) then the ancillary electronic device 200 may be configured to receive a speech input. By contrast, if the ancillary electronic device is in a different location, e.g., office, then the ancillary electronic device 200 may be configured to receive a motion-based input,

At operation 435 it is determined whether the instruction received at operation 430 corresponds to a greeting. In some examples the personal assistant manager 242 in the electronic device 200 may maintain one or more recorded instructions as greetings. The greetings may be generic (e.g., “hello”) or may be specifically adapted to contacts maintained for the remote electronic device (e.g., “hello Sarah”). Alternatively, or in addition, a greeting may be associated with a specific input on an input/output device. For example, depressing a specific button on a keypad may be assigned as a greeting. The instruction received at operation 430 may be compared to instructions recorded in memory to determine whether the instruction corresponds to a greeting.

If, at operation 435, the instruction received at operation 430 is not a greeting then control passes back to operation 430 and the electronic device 100 continues to monitor for an instruction. In this case the remote electronic device 200 may process the incoming call in accordance with normal operations.

By contrast, if at operation 435 the signal received at operation 430 includes a greeting then control passes to operation 440 and the greeting is buffered in memory. At operation 445 the electronic device 100 generates a connect call signal which is sent to remote electronic device 200. In some examples the connect call signal comprises the buffered greeting.

At operation 450 the remote electronic device 100 receives the connect call signal from the ancillary electronic device 200. At operation 455 the remote electronic device 100 answers the call, and at operation 460 the remote electronic device 100 presents the greeting to the caller. The call may then continue normally.

Thus, the operations depicted in FIG. 4 enable the electronic device 100 to answer an incoming call and provide a greeting with a single input.

In some examples the ancillary electronic device 200 may enable a user to interrupt a call in order to interact with additional features or applications on electronic device 100. For example, during a call a user may wish to interrupt the call to place a second call, sent a text message, or perform a calendar inquiry. Operations to implement this feature are depicted in FIG. 5.

Referring to FIG. 5, at operation 510 an interrupt signal is received in the ancillary electronic device 200. By way of example, an interrupt signal may be input via an input/output device on ancillary electronic device 200, e.g., by pressing a specific button, providing a predetermined input on a keypad, or the like. In response to an interrupt signal control passes to operation 515 and ancillary electronic device 200 may mute the call microphone. At operation 520 the ancillary electronic device generates a signal to place the call on hold. The signal is transmitted to the remote electronic device 100. At operation 525 the remote electronic device 100 places the call on hold.

At operation 530 the ancillary electronic device 200 initiates a separate session with the remote electronic device 100. For example, the separate session may comprise a separate phone call, text message, or interaction with an application which executes on remote electronic device 100.

At operation 535 the ancillary electronic device 200 receives a reconnect signal. By way of example, a reconnect signal may be input via an input/output device on ancillary electronic device 200, e.g., by pressing a specific button, providing a predetermined input on a keypad, or the like. In response to the reconnect signal the ancillary electronic device 200 transmits a signal to the remote electronic device 100 to reconnect the call, which the remote electronic device implements at operation 540.

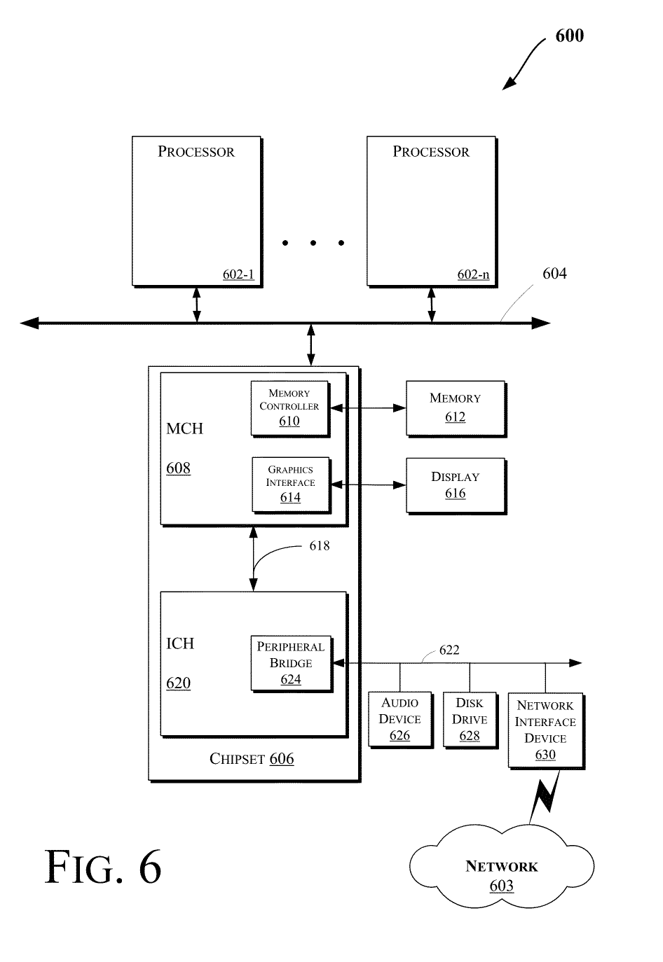

As described above, in some examples the electronic device may be embodied as a computer system. FIG. 6 illustrates a block diagram of a computing system 600 in accordance with an example. The computing system 600 may include one or more central processing unit(s) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 612 may store data, including sequences of instructions, that may be executed by the processor 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple processor(s) and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the processor 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

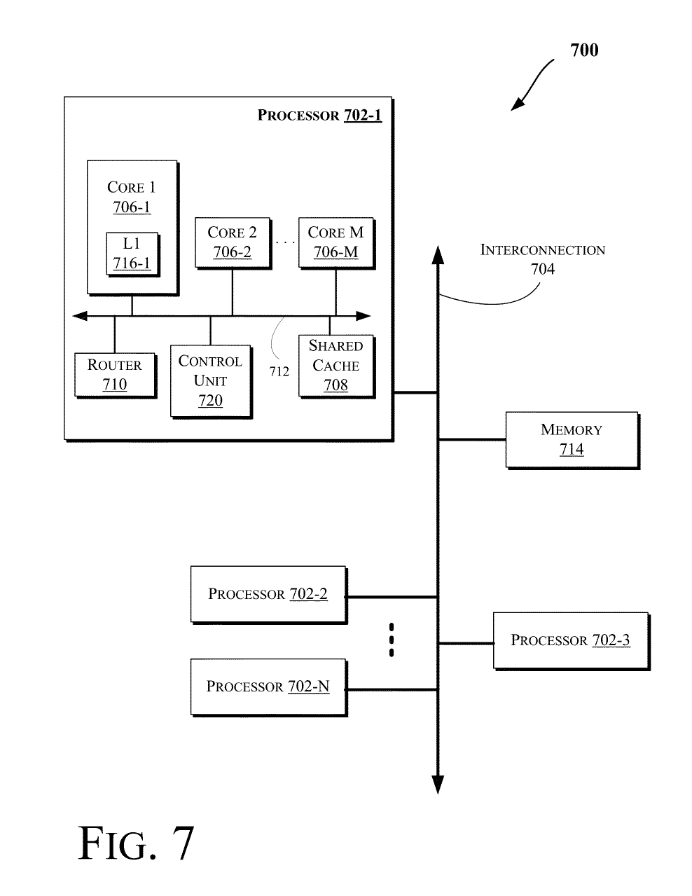

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”).

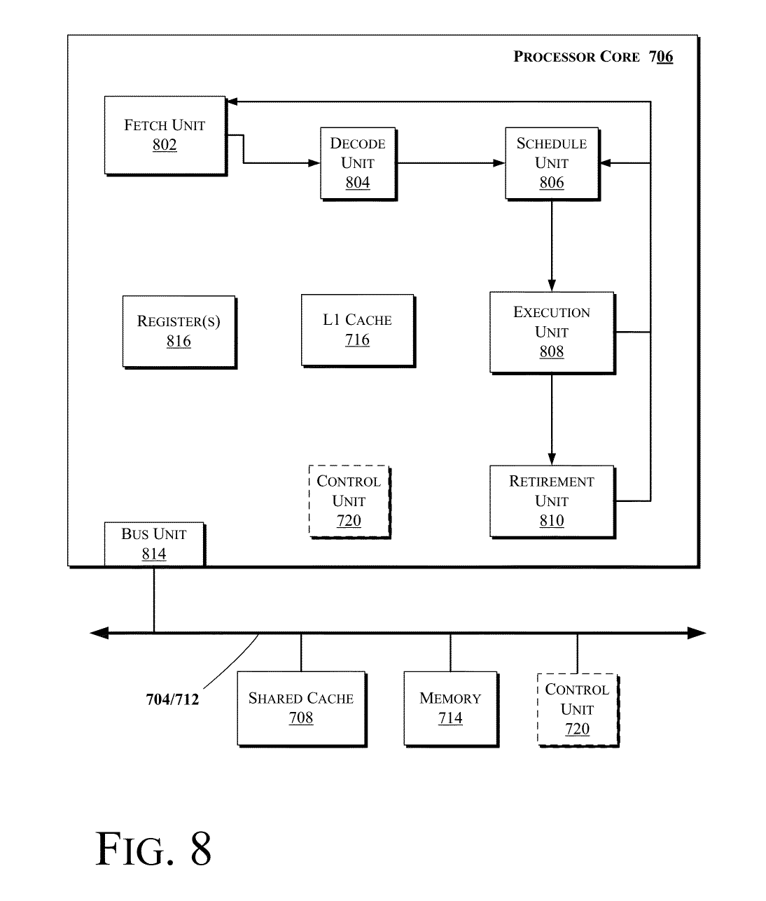

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

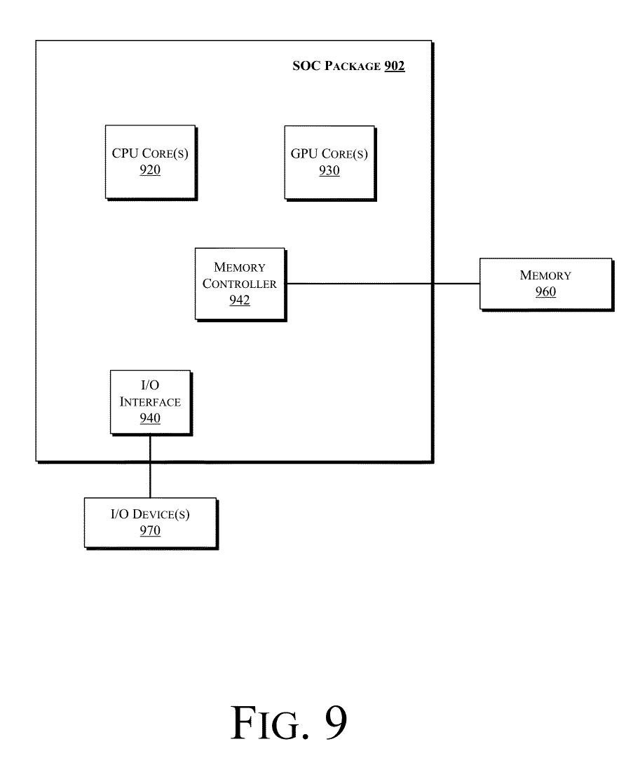

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more processor cores 920, one or more graphics processor cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch surface, a speaker, or the like.

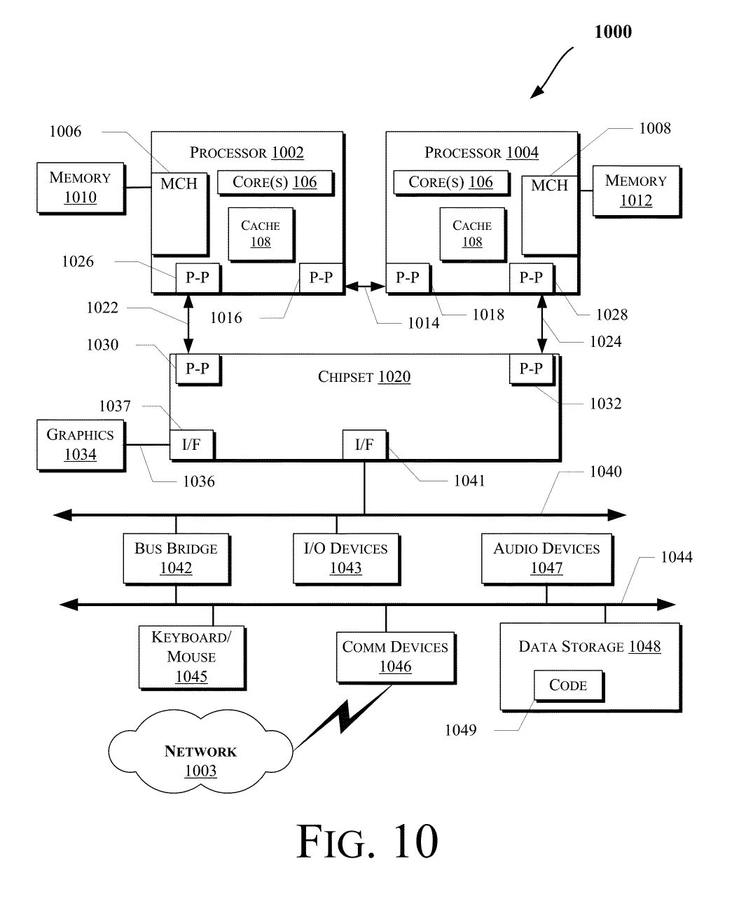

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic 125 of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 1003), audio I/O device, and/or a data storage device 1048. The data storage device 1048 (which may be a hard disk drive or a NAND flash based solid state drive) may store code 1049 that may be executed by the processors 1004.

The following pertain to further examples.

Example 1 is a controller comprising logic, at least partially including hardware logic, configured to receive a signal from a remote electronic device, and in response to the signal, present an announcement of an incoming call on the remote device. receive an instruction for the incoming call, and in response to a determination that the instruction is a greeting, buffer the greeting, forward an instruction to the remote electronic device to connect the call, wherein the instruction includes the greeting.

In Example 2, the subject matter of Example 1 can optionally include an arrangement in which the logic to present an announcement of an incoming call on the remote device comprises logic to present at least one of an audible alert on a speaker coupled to the controller, a visual alert on an output device coupled to the controller, or a tactile alert.

In Example 3, the subject matter of any one of Examples 1-2 can optionally include an arrangement in which wherein the logic to receive an instruction for the incoming call comprises logic to receive at least one of a voice command, a tactile command, a predetermined motion, a predetermined image, or a location input.

In Example 4, the subject matter of any one of Examples 1-3 can optionally include logic further configured to make a determination whether the instruction comprises a greeting comprises logic to compare the instruction to a recorded instruction in a memory.

In Example 5, the subject matter of any one of Examples 1-4 can optionally include logic further configured to receive an interrupt signal during the call, and in response to the input signal, to mute a microphone on an electronic device coupled to a controller, generate a signal to place the call on hold, and initiate a separate communication session with the remote electronic device.

In Example 6, the subject matter of any one of Examples 1-5 can optionally include logic further configured to receive a signal to reconnect the call, and in response to the signal, to generate a signal to reconnect the call.

Example 7 is an electronic device comprising a speaker, a recording device, and a controller comprising logic, at least partially including hardware logic, configured to receive a signal from a remote electronic device, and in response to the signal to present an announcement of an incoming call on the remote device, receive an instruction for the incoming call, and in response to a determination that the instruction is a greeting, to buffer the greeting, forward an instruction to the remote electronic device to connect the call, wherein the instruction includes the greeting.

In Example 8, the subject matter of Example 7 can optionally include an arrangement in which the logic to present an announcement of an incoming call on the remote device comprises logic to present at least one of an audible alert on a speaker coupled to the controller, a visual alert on an output device coupled to the controller, or a tactile alert.

In Example 9, the subject matter of any one of Examples 7-8 can optionally include an arrangement in which wherein the logic to receive an instruction for the incoming call comprises logic to receive at least one of a voice command, a tactile command, a predetermined motion, a predetermined image, or a location input.

In Example 10, the subject matter of any one of Examples 7-9 can optionally include logic further configured to make a determination whether the instruction comprises a greeting comprises logic to compare the instruction to a recorded instruction in a memory.

In Example 11, the subject matter of any one of Examples 7-10 can optionally include logic further configured to receive an interrupt signal during the call, and in response to the input signal, to mute a microphone on an electronic device coupled to a controller, generate a signal to place the call on hold, and initiate a separate communication session with the remote electronic device.

In Example 12, the subject matter of any one of Examples 7-11 can optionally include logic further configured to receive a signal to reconnect the call, and in response to the signal, to generate a signal to reconnect the call.

Example 13 is a computer program product comprising logic instructions stored on a tangible computer readable medium which, when executed by a controller, configure the controller to receive a signal from a remote electronic device, and in response to the signal to present an announcement of an incoming call on the remote device, receive an instruction for the incoming call, and in response to a determination that the instruction is a greeting, to buffer the greeting, forward an instruction to the remote electronic device to connect the call, wherein the instruction includes the greeting.

In Example 14, the subject matter of Example 13 can optionally include an arrangement in which the logic to present an announcement of an incoming call on the remote device comprises logic to present at least one of an audible alert on a speaker coupled to the controller, a visual alert on an output device coupled to the controller, or a tactile alert.

In Example 15, the subject matter of any one of Examples 13-14 can optionally include an arrangement in which wherein the logic to receive an instruction for the incoming call comprises logic to receive at least one of a voice command, a tactile command, a predetermined motion, a predetermined image, or a location input.

In Example 16, the subject matter of any one of Examples 13-15 can optionally include logic further configured to make a determination whether the instruction comprises a greeting comprises logic to compare the instruction to a recorded instruction in a memory.

In Example 17, the subject matter of any one of Examples 13-16 can optionally include logic further configured to receive an interrupt signal during the call, and in response to the input signal, to mute a microphone on an electronic device coupled to a controller, generate a signal to place the call on hold, and initiate a separate communication session with the remote electronic device.

In Example 18, the subject matter of any one of Examples 13-17 can optionally include logic further configured to receive a signal to reconnect the call, and in response to the signal, to generate a signal to reconnect the call.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and examples are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and examples are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and examples are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular examples, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one example” or “some examples” means that a particular feature, structure, or characteristic described in connection with the example is included in at least an implementation. The appearances of the phrase “in one example” in various places in the specification may or may not be all referring to the same example.

Although examples have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A controller, comprising:
logic, at least partially including hardware logic, configured to:
receive a signal from a remote electronic device; and
in response to the signal:
present an announcement of an incoming call on the remote device;
receive an instruction for the incoming call; and
in response to a determination that the instruction is a greeting:
buffer the greeting;
forward an instruction to the remote electronic device to connect the call, wherein the instruction includes the greeting.

2. The controller of claim 1, wherein the logic to present an announcement of an incoming call on the remote device comprises logic to present at least one of:
an audible alert on a speaker coupled to the controller;
a visual alert on an output device coupled to the controller; or
a tactile alert.

3. The controller of claim 2, wherein the logic to receive an instruction for the incoming call comprises logic to receive at least one of:
a voice command;
a tactile command;
a predetermined motion;
a predetermined image; or
a location input.

4. The controller of claim 1, further comprising logic to make a determination whether the instruction comprises a greeting comprises logic to compare the instruction to a recorded instruction in a memory.

5. The controller of claim 1, further comprising logic to:
receive an interrupt signal during the call; and
in response to the input signal, to:
mute a microphone on an electronic device coupled to a controller;
generate a signal to place the call on hold; and
initiate a separate communication session with the remote electronic device.

6. The controller of claim 5, further comprising logic to:
receive a signal to reconnect the call; and
in response to the signal, to:
generate a signal to reconnect the call.

7. An electronic device, comprising:
a speaker;
a recording device; and
a controller, comprising:
logic, at least partially including hardware logic, configured to:
receive a signal from a remote electronic device; and
in response to the signal:
present an announcement of an incoming call on the remote device;
receive an instruction for the incoming call; and
in response to a determination that the instruction is a greeting:
buffer the greeting;
forward an instruction to the remote electronic device to connect the call, wherein the instruction includes the greeting.

8. The electronic device of claim 7, wherein the logic to present an announcement of an incoming call on the remote device comprises logic to present at least one of:
an audible alert on a speaker coupled to the controller;
a visual alert on an output device coupled to the controller; or
a tactile alert.

9. The electronic device of claim 8, wherein the logic to receive an instruction for the incoming call comprises logic to receive at least one of:
a voice command;
a tactile command;
a predetermined motion;
a predetermined image; or
a location input.

10. The electronic device of claim 7, further comprising logic to make a determination whether the instruction comprises a greeting comprises logic to compare the instruction to a recorded instruction in a memory.

11. The electronic device of claim 7, further comprising logic to:
receive a predetermined input signal during the call; and
in response to the input signal, to:
place the call on hold;
mute a microphone on an electronic device coupled to a controller; and
initiate a separate communication session with the remote electronic device.

12. The electronic device of claim 7, further comprising logic to:
receive a signal to reconnect the call; and
in response to the signal, to:
generate a signal to reconnect the call.

13. A computer program product comprising logic instructions stored on a tangible computer readable medium which, when executed by a controller, configure the controller to:
receive a signal from a remote electronic device; and
in response to the signal:
present an announcement of an incoming call on the remote device;
receive an instruction for the incoming call; and
in response to a determination that the instruction is a greeting:
buffer the greeting;
forward an instruction to the remote electronic device to connect the call, wherein the instruction includes the greeting.

14. The computer program product of claim 13, comprising logic instructions stored on a tangible computer readable medium which, when executed by the controller, configure the controller to present at least one of:
an audible alert on a speaker coupled to the controller;
a visual alert on an output device coupled to the controller; or
a tactile alert.

15. The computer program product of claim 14, comprising logic instructions stored on a tangible computer readable medium which, when executed by the controller, configure the controller to receive at least one of:
a voice command;
a tactile command;
a predetermined motion;
a predetermined image; or
a location input.

16. The computer program product of claim 13, comprising logic instructions stored on a tangible computer readable medium which, when executed by the controller, configure the controller to compare the instruction to a recorded instruction in a memory.

17. The computer program product of claim 13, comprising logic instructions stored on a tangible computer readable medium which, when executed by the controller, configure the controller to:
receive a predetermined input signal during the call; and
in response to the input signal, to:
place the call on hold;
mute a microphone on an electronic device coupled to a controller; and
initiate a separate communication session with the remote electronic device.

18. The computer program product of claim 13, comprising logic instructions stored on a tangible computer readable medium which, when executed by the controller, configure the controller to:
receive a signal to reconnect the call; and
in response to the signal, to:
generate a signal to reconnect the call.
